(19) United States
(12) Patent Application Publication
(10) Pub. No.: US 2026/0200295 A1
(43) Pub. Date: Jul. 16, 2026

(54) Coolant Circuit

(71) Applicant: MAHLE International GmbH, Stuttgart (DE)

(72) Inventors: Hans-Ulrich Steurer, Stuttgart (DE); Thomas Strauß, Notzingen (DE); Sascha Lindauer, Schorndorf (DE)

(21) Appl. No.: 19/422,294

(22) Filed: Dec. 16, 2025

(30) Foreign Application Priority Data
Dec. 17, 2024 (DE) 102024138370.4

(51) Int. Cl. B60H 1/32; B60H 1/00

(52) U.S. Cl. CPC B60H 1/32284; B60H 1/00278; B60H 1/3227

(57) ABSTRACT

A coolant circuit, in particular for a motor vehicle, which has a refrigerant circuit is provided. The coolant circuit includes with a compressor, a first heat exchanger and second heat exchanger, and has at least two expansion valves, wherein the first heat exchanger is connected to a first fluid circuit wherein the first fluid circuit also contains a pump and a heater, wherein the second heat exchanger is connected to a second fluid circuit, wherein the second fluid circuit contains a pump, and wherein there is a third fluid circuit in which there is at least one temperature-controlled unit, wherein there is a valve assembly for controlling the flow and/or connection of the first fluid circuit, second fluid circuit, and/or third fluid circuit.

### CROSS-REFERENCE TO RELATED APPLICATIONS

This application claims priority from German Patent Application No. 102024138370.4, filed on Dec. 17, 2024, the entirety of which is hereby incorporated by reference herein.

The invention relates to a coolant circuity, specifically for a motor vehicle.

Heating the passenger compartment and various units in electric vehicles is a special problem because there is no exhaust heat from an internal combustion engine, and even with hybrid vehicles there is very little, making it more difficult to generate such heat.

It is therefore the object of the invention to create an effective coolant circuit with which the vehicle can be heated simply and effectively, in particular if at least two different parts of the vehicle must be heated to different temperatures.

This problem is solved with the features of Numbered Paragraph 1.

One solution relates to a coolant circuit for a vehicle that contains a refrigerant circuit with a compressor, a first heat exchanger, a second heat exchanger, and at least two adjustable expansion valves, in which the first heat exchanger is connected to a first fluid circuit that contains a pump and a heater, the second heat exchanger is connected to a second fluid circuit that contains a pump, a third fluid circuit contains a temperature-controlled unit, and there is a valve assembly that regulates and or controls the flow through the first circuit, second circuit and third circuit. Consequently, the fluids in the first and third circuits can be at different temperatures because the temperature in the third circuit can be controlled by the valve assembly, such that it differs from that in the first circuit. The temperature in the second circuit can also be different.

Ideally, there is also a first control valve and third heat exchanger in the first circuit, and this control valve allows fluid to flow through the third heat exchanger or a bypass. This controls the temperature in the third heat exchanger.

The third heat exchanger is preferably a heater through which air flows. This is used to control the temperature in the vehicle's passenger compartment.

The second fluid circuit also has a bypass, and there is a second control valve that controls the flow therethrough. This controls the temperature and amount of fluid flowing through the second circuit to or from the valve assembly, such that the temperature of the fluid in the third circuit can be adjusted.

The second fluid circuit ideally has a fourth heat exchanger. This can be used for additional heating of the air for the passenger compartment, or heating some other unit.

It is advantageous if air can flow through the fourth heat exchanger, which acts as a cooling element and is parallel to the third heat exchanger. This can be used to cool the air supplied to the vehicle interior.

Ideally, the unit in the third circuit is a battery. The temperature thereof can be effectively regulated by the third circuit.

Preferably the unit in the third circuit, e.g. a battery, can be heated and/or cooled. Consequently, the current temperature of the unit can be taken into account.

It is advantageous when the valve assembly is connected to all three fluid circuits. In this case, the valve assembly can affect or control the temperatures of each circuit.

The valve assembly is ideally an integrated assembly for controlling the three fluid circuits. This valve assembly can also comprise multiple valves.

It is also advantageous when compressor has an intake and an outlet, the first heat exchanger has a first intake and first outlet, the second heat exchanger has a second intake and second outlet, and the compressor's outlet is connected to the first intake, the first outlet is connected to the second intake, the second outlet is connected to the compressor's intake, and there is a first adjustable expansion valve upstream of the second heat exchanger, a bypass is formed between the compressor outlet and the compressor intake in which there is a second adjustable expansion valve, and a third adjustable expansion valve can be placed downstream of the compressor and upstream of the first heat exchanger.

In another design, the second control valve controls the volumetric flow through the second heat exchanger and the second bypass such that the target temperature is reached at the entry to the temperature-controlled unit.

The setting of the second control valve is ideally delimited by a limitation of the compressor, i.e. its rotational rate and/or capacity.

It is advantageous when the heat output for the third heat exchanger is reduced in order to increase the heat output for the temperature-controlled unit.

The invention shall be explained in greater detail below based on exemplary embodiments in reference to the drawings.

Therein:

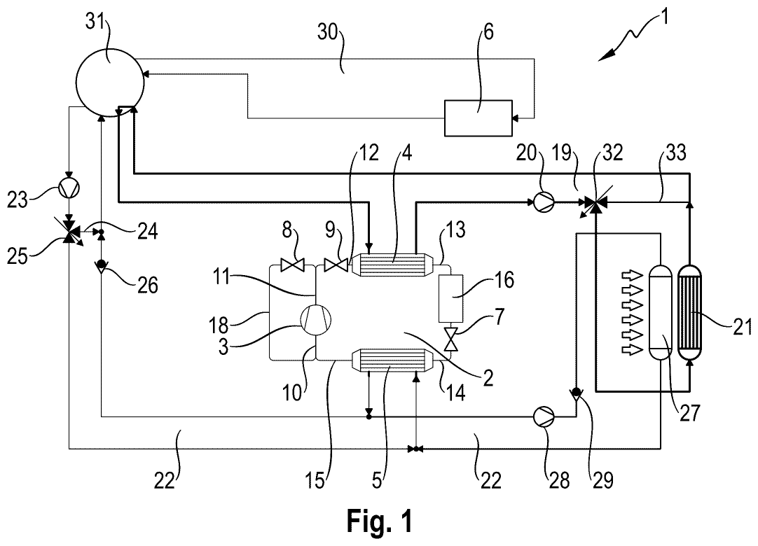

FIG. 1 shows a schematic illustration of an exemplary embodiment of the coolant circuit obtained with the invention,

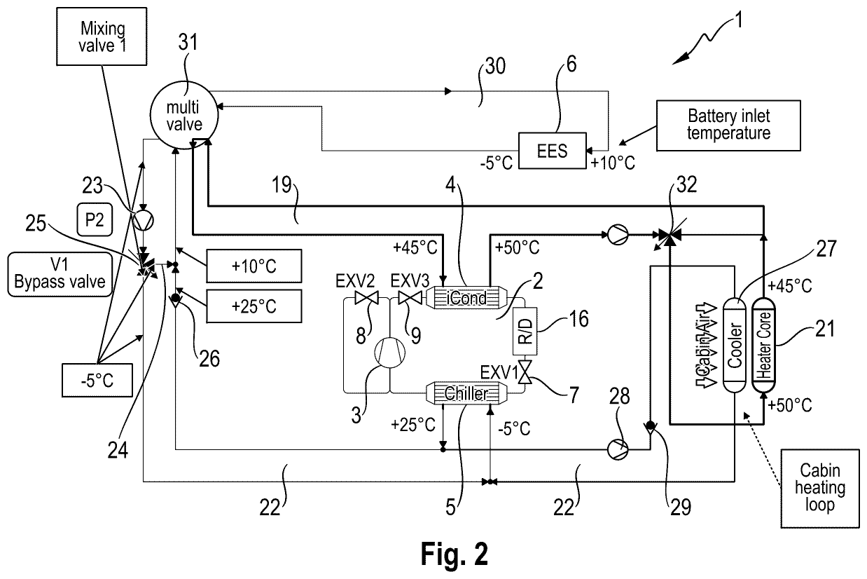

FIG. 2 shows a schematic illustration of the exemplary embodiment of the coolant circuit in FIG. 1, in a first operating state,

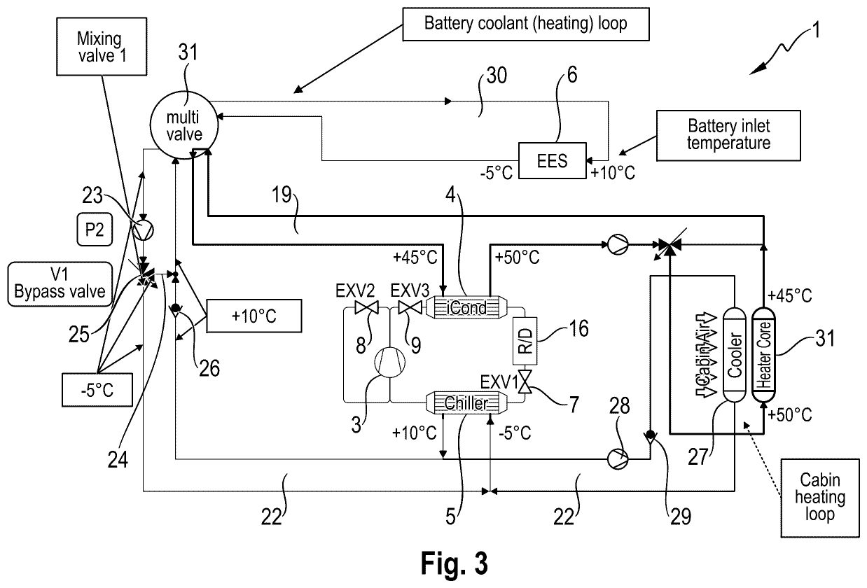

FIG. 3 shows a schematic illustration of the exemplary embodiment of the coolant circuit in FIG. 1, in a second operating state, and

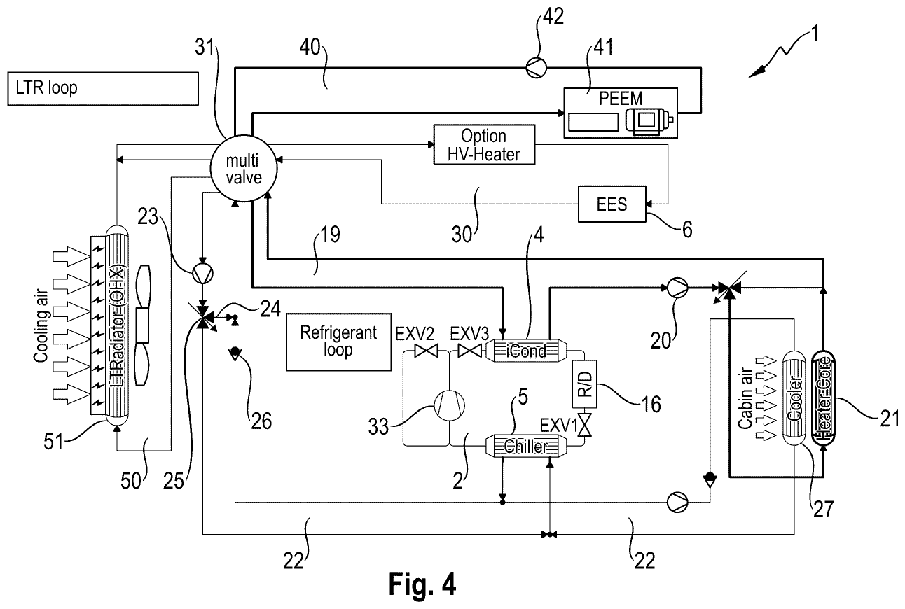

FIG. 4 shows a schematic illustration of another exemplary embodiment of the coolant circuit obtained with the invention.

FIG. 1 shows a schematic illustration of a coolant circuit 1 for a motor vehicle.

This coolant circuit 1 is used to heat or regulate the temperature of a vehicle interior, i.e. the passenger compartment, and can also be used to heat or regulate the temperature of at least one unit 6, e.g. a battery.

The coolant circuit 1, specifically used as a heating circuit for a motor vehicle, is formed by a refrigerant circuit 2 that contains a compressor 3, a first heat exchanger 4 and a second heat exchanger 5.

The refrigerant circuit 2 also contains at least two adjustable expansion valves 7, 8. There can also be a third expansion valve 9.

The compressor 3 has an intake 10, and an outlet 11. The first heat exchanger 4 has a first intake 12 and a first outlet 13, and the second heat exchanger 5 has a second intake 14 and a second outlet 15. There is a reservoir 16 between the first heat exchanger 4 and second heat exchanger 5, which may contain a dehumidifier and/or filter.

The compressor's outlet 11 is connected to the first intake 12, the first outlet 13 is connected to the second intake 14, and the second outlet 15 is connected to the compressor's intake 10.

There is a first adjustable expansion valve 7 upstream of the second heat exchanger 5, and a bypass 18 is formed between the compressor's outlet 11 and its intake 10 that contains a second adjustable expansion valve 8.

There can be a third adjustable expansion valve 9 downstream of the compressor 3 and upstream of the first heat exchanger 4.

The first heat exchanger 4 is connected to a first fluid circuit 19, which contains a pump 20 and a heater 21.

There is an optional first control valve 31 and third heat exchanger 21 in the first fluid circuit 19. The optional first control valve 32 controls the flow through the third heat exchanger 21 and/or a first bypass 33 for the third heat exchanger 21. The optional control valve 32 is used for the thermal management of the vehicle and its interior. This temperature control can also be obtained at the third heat exchanger 21 by vents in the air conditioner. In this case, the control valve 32 and the line from the control valve 32 to connecting points following the third heat exchanger 21 are unnecessary.

The third heat exchanger is a heater through which air can flow.

The second heat exchanger 5 is connected to a second fluid circuit 22 that contains a pump 23. The second circuit 22 has a bypass 24, a second control valve 25 that controls the flow through the second bypass 24, and a check valve 26. The second circuit 22 can also contain a fourth heat exchanger 27, which also contains a pump 28 and check valve 29.

Air flows through the fourth heat exchanger 27, which forms a cooling element. The fourth heat exchanger 27 is advantageously upstream of the third heat exchanger 21 in the airflow. The cooling element can replace an evaporator for cooling air. In this case, the cooling element, i.e. the fourth heat exchanger 27, would be upstream of the heater, i.e. the third heat exchanger 21 in the air flow in an air conditioner, for example.

There is also a third fluid circuit 30, which is for the temperature-controlled unit 6. This unit 6 in the third fluid circuit 30 can be a battery. The temperature-controlled unit 6 can be heated and/or cooled in the third fluid circuit 30.

There is also a valve assembly 31 that controls the flow of fluid through the first circuit 19, second circuit 22, and/or third circuit 30. The first circuit 19, second circuit 22, and third circuit 30 are connected to this valve assembly 31. The valve assembly 31 regulates the flow through the circuit 19, 22, 30 and thus the temperature of the fluids therein.

In one design, the valve assembly 31 is an integrated valve assembly for controlling the first fluid circuit 19, second fluid circuit 22, and third fluid circuit 30. This valve assembly 31 can contain multiple valves.

The refrigerant circuit 2 has a Compressor 3 for the Refrigerant Circulating Therein.

There is also a first heat exchanger 4 in the form of a condenser through which a fluid can flow, and a second heat exchanger 5, in particular a chiller. The first heat exchanger 4 is downstream of the compressor 3, and the second heat exchanger 5 is downstream of the first heat exchanger 4 in the refrigerant circuit 2.

There are also at least two expansion valves 7, 8. There are actually three expansion valves 7, 8, 9 in the exemplary embodiment shown in FIG. 1. These expansion valves 7, 8, 9 are adjustable.

The compressor 3 has an intake 10 and an outlet 11. The first heat exchanger 4 has a first intake 12 and first outlet 13, and the second heat exchanger 5 has a second intake 14 and second outlet 15.

The configuration shown in FIG. 1 is such that the compressor's outlet 11 is connected to the first intake 12, the first outlet 13 is connected to the second intake 14, and the second outlet 15 is connected to the compressor's intake 10.

There is a first expansion valve 7 upstream of the second heat exchanger 5, and a bypass 18 is formed between the compressor's outlet 11 and inlet 10 that contains a second expansion valve 8.

It is particularly advantageous when there is a third expansion valve 9 downstream of the compressor 3 and upstream of the first heat exchanger 4.

The refrigerant circuit 2 is operated with a refrigerant, in particular a refrigerant without fluorides, e.g. CO2, propane, R134, 1234yf, etc.

The first heat exchanger 4 is a refrigerant/liquid heat exchanger connected to a fluid circuit 19 that contains a liquid/air heat exchanger 21 for heating the air in a vehicle cab. It may be advantageous if the liquid is a coolant, in particular a water-based coolant.

The second heat exchanger 5 is preferably a chiller for a refrigerant/liquid heat exchanger in which the liquid is preferably a coolant, in particular a water-based coolant. This coolant can then be used in a separate fluid circuit 22 for heating or cooling a temperature-controlled unit 6, e.g. a vehicle battery or some other unit.

In the present exemplary embodiment, the refrigerant circuit 2 and/or coolant circuit 1 are controlled by the expansion valves 7, 8, 9, the pumps 20, 23, 28, the compressor 3, specifically the rotational rate thereof, the valve assembly 31, and/or the control valves 25, 32.

In a stable operating state of the refrigerant circuit 2, the rotational rate of the compressor is used to control the heat output via the temperature of the fluid at the heater 21.

The expansion valve 7 controls overheating at the outlet on the compressor 3.

The expansion valve 8 controls the suction pressure of the compressor 3 in the refrigerant circuit 2.

The expansion valve 9 the refrigerant circuit 2 when it is starting up.

In the stable operating state of the fluid circuits 19, 22, 30, the pump 20 controls the flow of fluid through the circuit 19. The pump 23 controls the flow of fluid through the circuit 30.

The valve assembly 31 connects the circuit 30 to the circuit 22 and/or connects the two ports in the circuit 19 when it functions as a heating circuit, e.g. when the first heat exchanger 4 and the heater 21 are connected therein.

The second control valve 25 divides the flow between the bypass 24 and the heat exchanger 5.

By this means, the circuits can be controlled such that the heater 21 heats the vehicle's interior, and the heating capacity requirements for the heater 21 are defined by the vehicle interior. Consequently, the preheating temperature of the heater 21 in the first fluid circuit 19, which serves as the heating circuit, is defined as the primary variable.

The preheating temperature of the temperature-controlled unit 6, e.g. a battery that can be heated, can be regarded as another variable.

This preheating temperature for the unit 6, e.g. a battery, can also be used as the primary variable. In this case, the control valve 25 forms a bypass valve that controls the flow rate through the bypass 24 and to the second heat exchanger 5, e.g. a chiller. The flow at the unit 6 is defined by the pump 23, and the flow at the second heat exchanger 5 is defined by the control valve 25, depending on the fluid intake temperature, i.e. the preheating temperature, at the unit 6, e.g. a battery, or based on the difference in temperatures between the saturation temperature at the second heat exchanger 5, i.e. a refrigerant temperature, and the fluid intake temperature at the unit 6, e.g. a battery.

Alternatively, the control valve 25 can control the flow at the second heat exchanger 5, in which case the absolute flow at the unit 6 and second heat exchanger 5 is controlled by the pump 23, based on the saturation temperature of the refrigerant at the second heat exchanger 5.

Typically, heating the vehicle cab with the heater 21 has priority. The unit 6 is then heated in the background, or not at all.

There are some situations in which heating the unit 6 has greater priority. This may be the case when not all of the heat supplied by the compressor 3 is needed for heating the vehicle cab with the heater 21.

The unit 6 can be heated if the rotational rate of the compressor falls below a predefined threshold value, e.g. 80% of the maximum rotational rate for the compressor 3. In this case, the rotational rate is already lowered, because the heat output needed for heating the vehicle cab with the heater 21 is already lower. In this case, the compressor 3 can be operated at its maximum capacity, and the excess can be used to heat the unit 6.

This maximum rotational rate can be used as a limit for heating the unit 6. The maximum rotational rate may depend on a variety of variables, e.g. the noise generated by the compressor, the speed at which the vehicle is travelling, the outside temperature, and/or other priority definitions, e.g. a booster mode or a capacity limit. A booster mode is an operating mode with a temporally limited increase in the heating capacity, in order to heat up more quickly. This capacity limitation can be obtained, for example, through an electricity output limit determined by the vehicle power consumption management.

Heating the unit 6 may also have a higher priority than heating the vehicle interior with the heater 21. This may be the case if the battery 6 must be charged quickly, because it is easier to charge the battery quickly if it is already heated to within a predefined temperature range.

Dividing the heating output between heating the unit 6 and heating the vehicle interior with the heater 21 can be obtained with either of the following modes:
1. The highest priority is heating the vehicle cab with the heater 21:
   in this mode, heating the unit 6, e.g. a battery, is only possible when heating the cab has reached the point where the rotational rate of the compressor has fallen below its maximum, preferably to a defined rate.
2. Highest priority is heating the unit 6:
   in this mode, heating the unit 6 takes priority, such that heating the cab is reduced to the point that a selected portion of the available energy can be used to heat the unit 6, e.g. a battery.

FIGS. 2 and 3 each show schematic illustrations of the exemplary embodiment of the coolant circuit in FIG. 1, in a first and second operating state, respectively.

FIG. 2 shows that the temperature of the fluid is −5° C. at the intake for the second heat exchanger 5, and 25° C. at the outlet. The temperature at the intake to the unit 6 is 10° C., and −5° C. at the outlet.

The control valve 25 controls the flow through the bypass 24 and to the second heat exchanger 5 such that the fluid coming from the second heat exchanger 5 at 25° C. mixes with that from the unit 6 at −5° C., to obtain a temperature of 10° C. in the fluid flowing to the unit 6.

The second control valve 25 therefore controls the temperature at the intake for the unit 6 based on the temperature at the outlet on the second heat exchanger 6 and the outlet at the unit 6.

FIG. 3 shows that the temperature of the fluid is −5° C. at the intake for the second heat exchanger 5, and 10° C. at the outlet. FIG. 3 also shows that the temperature of the fluid is 10° C. at the intake for the unit 6, and −5° C. at the outlet.

The valve 25 controls the flow through the bypass 24 and to the second heat exchanger 5, such that bypass 24 is closed. Consequently, all of the fluid flows from the unit 6 to the second heat exchanger 5, where it is then reheated to 10° C.

FIG. 4 shows another design for the coolant circuit 1, which is formed by a refrigerant circuit 2, a compressor 3, a first heat exchanger 4, and a second heat exchanger, in which the first heat exchanger 4 is connected to a first fluid circuit 19 that contains a pump 20 and a heater 21, as is the case with the coolant circuit in FIG. 1. The second heat exchanger 5 is connected to a second fluid circuit 22 that contains a pump 23, and there is a third fluid circuit 30 that contains at least one temperature-controlled unit 6, as is also the case in FIG. 1.

There are two additional fluid circuits 40 and 50 therein, to which the valve assembly 31 is connected. This valve assembly 31 can connect the circuits 22, 30, 40, and 50, and/or shut off circuit 19 such that it operates as a closed circuit.

Circuit 40 regulates the temperature of a unit 41, which can be an electric motor. There is also a pump in this circuit 40, for controlling the flow therein.

Circuit 50 has a low-temperature cooler 51 with which the temperature of the fluid therein and in at least one of the other circuits 22, 19, 30, and 40 can be regulated.

The specification can be readily understood with reference to the following Numbered Paragraphs:
Numbered Paragraph 1. A coolant circuit (1), in particular for a motor vehicle, which has a refrigerant circuit (2) with a compressor (3), a first heat exchanger (4) and second heat exchanger (5), and has at least two expansion valves (7, 8), wherein the first heat exchanger (4) is connected to a first fluid circuit (19), wherein the first fluid circuit (19) also contains a pump (20) and a heater (21), wherein the second heat exchanger (5) is connected to a second fluid circuit (22), wherein the second fluid circuit (22) contains a pump (23), and wherein there is a third fluid circuit (30) in which there is at least one temperature-controlled unit (6), wherein there is a valve assembly (31) for controlling the flow and/or connection of the first fluid circuit (19), second fluid circuit (22), and/or third fluid circuit (30).
Numbered Paragraph 2. The coolant circuit (1) according to Numbered Paragraph 1, characterized in that there is a third heat exchanger (21) in the first fluid circuit (19).
Numbered Paragraph 3. The coolant circuit (1) according to Numbered Paragraph 1 or 2, characterized in that the third heat exchanger (21) is a heater through which air flows.
Numbered Paragraph 4. The coolant circuit (1) according to Numbered Paragraph 1, 2, or 3, characterized in that the second fluid circuit (22) has a second bypass (24), wherein there is a second control valve (25) that controls the flow through the second bypass (24).
Numbered Paragraph 5. The coolant circuit (1) according to any of the preceding Numbered Paragraphs, characterized in that the second fluid circuit (22) contains a fourth heat exchanger (27).
Numbered Paragraph 6. The coolant circuit (1) according to any of the preceding Numbered Paragraphs, characterized in that air flows through the fourth heat exchanger (27), which serves as a cooling element, and is upstream of the third heat exchanger (21) in the airflow direction.
Numbered Paragraph 7. The coolant circuit (1) according to any of the preceding Numbered Paragraphs, characterized in that the temperature-controlled unit (6) in the third fluid circuit (30) is a vehicle battery.
Numbered Paragraph 8. The coolant circuit (1) according to any of the preceding Numbered Paragraphs, characterized in that the temperature-controlled unit (6) in the third fluid circuit (30) can be heated and/or cooled.
Numbered Paragraph 9. The coolant circuit (1) according to any of the preceding Numbered Paragraphs, characterized in that there is a valve assembly (31) to which the first fluid circuit (19), second fluid circuit (22), and third fluid circuit (30) are attached.
Numbered Paragraph 10. The coolant circuit (1) according to any of the preceding Numbered Paragraphs, characterized in that the valve assembly (31) is an integrated assembly that controls the first fluid circuit (19), second fluid circuit (22), and third fluid circuit (30).
Numbered Paragraph 11. The coolant circuit (1) according to any of the preceding Numbered Paragraphs, characterized in that the compressor (3) has an intake (10) and outlet (11), the first heat exchanger (4) has a first intake (12) and first outlet (13), and the second heat exchanger (5) has a second intake (14) and second outlet (15), wherein the compressor's outlet (11) is connected to the first intake (12), the first outlet (13) is connected to the second intake (14), and the second outlet (15) is connected to the compressor's intake (10), wherein there is a first adjustable expansion valve (7) upstream of the second heat exchanger (5), and wherein a bypass (18) is formed between the compressor's outlet (11) and the compressor's intake (10) in which there is a second adjustable expansion valve (8), and a third adjustable expansion valve (9) can be placed downstream of the compressor (3) and upstream of the first heat exchanger (4).
Numbered Paragraph 12. The coolant circuit (1) according to any of the preceding Numbered Paragraphs, characterized in that the second control valve (25) controls the volumetric flow through the second heat exchanger (5) and second bypass (24) such that the target temperature is reached at the entry to the temperature-controlled unit (6).
Numbered Paragraph 13. The coolant circuit (1) according to Numbered Paragraph 12, characterized in that the setting of the second control valve (25) is delimited by a limitation of the compressor (3), specifically its rotational rate and/or capacity.
Numbered Paragraph 14. The coolant circuit (1) according to any of the preceding Numbered Paragraphs, characterized in that the heat output for the third heat exchanger (21) is reduced to increase the heat output for the unit (6).

### LIST OF REFERENCE SYMBOLS

1 coolant circuit
2 refrigerant circuit
3 compressor
4 first heat exchanger
5 second heat exchanger
6 unit
7 first expansion valve
8 second expansion valve
9 third expansion valve
10 compressor's intake
11 compressor's outlet
12 first intake
13 first outlet
14 second intake
15 second outlet
16 reservoir
18 bypass
19 first fluid circuit
20 pump
21 heater/third heat exchanger/liquid/air heat exchanger
22 second fluid circuit
23 pump
24 second bypass
25 second control valve
26 check valve
27 fourth heat exchanger
28 pump
29 check valve
30 third fluid circuit
31 valve assembly
32 first control valve
33 first bypass
40 fluid circuit
41 unit
42 pump
50 fluid circuit
51 low-temperature cooler

1-14. (canceled)

15. A coolant circuit for a motor vehicle, comprising a refrigerant circuit with a compressor, a first heat exchanger and second heat exchanger, and has at least two expansion valves, wherein the first heat exchanger is connected to a first fluid circuit, wherein the first fluid circuit further comprises a pump and a heater, wherein the second heat exchanger is connected to a second fluid circuit, wherein the second fluid circuit further comprises a pump, and further comprising a third fluid circuit in which there is at least one temperature-controlled unit, further comprising a valve assembly configured for controlling the flow and/or connection of the first fluid circuit, second fluid circuit, and/or third fluid circuit.

16. The coolant circuit according to claim 15, further comprising a third heat exchanger in the first fluid circuit.

17. The coolant circuit according to claim 15, wherein the third heat exchanger comprises a heater through which air flows.

18. The coolant circuit according to claim 15, wherein the second fluid circuit comprises a second bypass, and further comprising a second control valve that controls the flow through the second bypass.

19. The coolant circuit according to claim 15, wherein the second fluid circuit comprises a fourth heat exchanger.

20. The coolant circuit according to claim 15, wherein air flows through the fourth heat exchanger, which serves as a cooling element, the third heat exchanger is upstream of the third heat exchanger in an airflow direction.

21. The coolant circuit according to claim 15, wherein the temperature-controlled unit in the third fluid circuit is a vehicle battery.

22. The coolant circuit according to claim 15, wherein the temperature-controlled unit in the third fluid circuit is configured to be heated and/or cooled.

23. The coolant circuit according to claim 15, further comprising a valve assembly to which the first fluid circuit, second fluid circuit, and third fluid circuit are attached.

24. The coolant circuit according to claim 15, wherein the valve assembly is an integrated assembly that is configured to control the first fluid circuit, second fluid circuit, and third fluid circuit.

25. The coolant circuit according to claim 15, wherein the compressor comprises an intake and outlet, the first heat exchanger comprises a first intake and first outlet, and the second heat exchanger comprises a second intake and second outlet, wherein the outlet of the compressor is connected to the first intake, the first outlet is connected to the second intake, and the second outlet is connected to the intake of the compressor, further comprising a first adjustable expansion valve upstream of the second heat exchanger, and wherein a bypass is formed between the compressor's outlet and the intake of the compressor in which there is a second adjustable expansion valve, and a third adjustable expansion valve is positioned placed downstream of the compressor and upstream of the first heat exchanger.

26. The coolant circuit according to claim 15, wherein the second control valve is configured to control a volumetric flow through the second heat exchanger and second bypass such that a target temperature is reached at the entry to the temperature-controlled unit.

27. The coolant circuit according to claim 26, wherein the setting of the second control valve is delimited by a rotational rate and/or capacity of the compressor.

28. The coolant circuit according to claim 15, wherein the heat output for the third heat exchanger is reduced to increase the heat output for the unit.
